(19) United States
(12) Patent Application Publication
(10) Pub. No.: US 2009/0004493 A1
(43) Pub. Date: Jan. 1, 2009

(54) (Meth)Acrylate Composition With Increased Storage Stability

(75) Inventors: Steffen Maier, Wettingen (CH); Ria De Cooman, Wettswil a.A. (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/223,299

(22) PCT Filed: Feb. 20, 2007
(86) PCT No.: PCT/EP2007/051615

§ 371 Date: Jul. 28, 2008

(30) Foreign Application Priority Data
Feb. 20, 2006 (EP) 06110171.3

(51) Int. Cl. C08K 3/22; B32B 7/12; B32B 27/36

(52) U.S. Cl. 428/480; 524/432; 524/430; 524/433; 156/327

(57) ABSTRACT

The present invention relates to compositions which comprise at least one organic (meth)acrylate, zinc(II) dimethacrylate and at least one metal oxide of the formula MO or M₂O₃ of a di- or trivalent metal selected from the group consisting of zinc and the main group metals. The compositions are stable in storage and on hardening give flexible materials which even at elevated temperatures still have good adhesion to various substrates and have good mechanical properties.

### FIELD OF THE INVENTION

The present invention pertains to the field of (meth)acrylate compositions, more particularly to that of (meth)acrylate adhesives and (meth)acrylate coatings.

### BACKGROUND ART

(Meth)acrylates have been used for some considerable time as adhesives and coatings, where they are cured under the influence of free radicals.

Zinc dimethacrylate has often been used in (meth)acrylate compositions since it enhances the properties of the material and the stability at elevated temperatures, but causes less severe embrittlement than conventional crosslinkers. It has emerged, however, that the addition of zinc dimethacrylate to a (meth)acrylate composition can result in a severe reduction in storage stability.

### BRIEF DESCRIPTION OF THE INVENTION

It is an object of the present invention, therefore, to provide a (meth)acrylate composition which at elevated temperature features improved mechanical properties and also good adhesion to numerous substrates, but whose storage stability is enhanced.

It has emerged that a composition as per claim 1 is able to achieve this object.

Compositions of this kind are distinguished, even at high temperatures, on the one hand by high adhesion to different substrates and on the other hand by enhanced mechanical properties, and are nevertheless storage-stable.

Surprisingly it has been possible to find that this effect can be achieved through the use of a specific combination of additives, namely of zinc(II) dimethacrylate and a metal oxide of certain divalent or trivalent metals, in organic (meth)acrylates.

These compositions can be cured free-radically and find application more particularly as adhesives or coatings. One substantial aspect of the invention concerns the use of a metal oxide of such divalent or trivalent metals for increasing the storage stability of a composition which comprises at least one organic (meth)acrylate and zinc(II) dimethacrylate.

### SOME EMBODIMENTS OF THE INVENTION

The present invention relates to compositions which comprise at least one organic (meth)acrylate, zinc(II) dimethacrylate, and also at least one metal oxide of the formula MO or M₂O₃, where M stands for a main-group metal or for zinc.

An “organic (meth)acrylate”, here and throughout the present document, is a monomer or oligomer which contains at least one ester group of acrylic acid or methacrylic acid and hence has at least one α,β-unsaturated double bond. Acrylic acid and methacrylic acid and also their salts are not understood to be “organic (meth)acrylate”.

Suitable organic (meth)acrylates are the (meth)acrylate monomers or oligomers that are known to the skilled worker. The (meth)acrylate monomers contain more particularly one, two or three (meth)acrylate groups.

Of more particular suitability are (meth)acrylates of the formula (I) or (II)

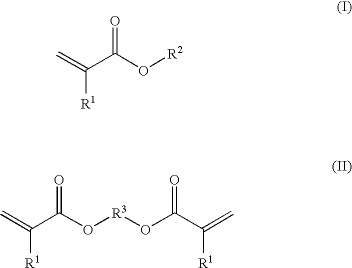

where R¹ stands for H or CH₃ and where R² represents a branched or unbranched organic radical which has more particularly 1 to 30, preferably 4 to 10, carbon atoms and which contains preferably at least one heteroatom, more particularly at least one O. R² may contain cyclic fractions of saturated, unsaturated or aromatic character.

Specified by way of example as (meth)acrylate monomers of the formula (I) are hydroxyethyl (meth)acrylate, hydroxypropyl (meth)acrylate, hydroxybutyl (meth)acrylate, methyl (meth)acrylate, ethyl (meth)-acrylate, 2-ethylhexyl (meth)acrylate, 2-phenoxyethyl (meth)acrylate, lauryl (meth)acrylate, stearyl (meth)acrylate, cyclohexyl (meth)acrylate, trim-ethylcyclohexyl (meth)acrylate, tert-butyl (meth)-acrylate, dicyclopentadienyl (meth)acrylate, dihydrodicyclopentadienyl acrylate, benzyl (meth)acrylate, isobornyl (meth)acrylate, polypropylene glycol mono(meth)acrylate, polyethylene glycol mono(meth)acrylate, tetrahydrofurfuryl (meth)acrylate, alkoxylated tetrahydrofurfuryl (meth)acrylate or alkoxylated phenol (meth)acrylate or lauryl (meth)acrylate.

R³ in formula (II) stands for a divalent organic radical which more particularly has 2 to 100 C atoms and preferably contains at least one heteroatom, more particularly at least one O. R³ may contain cyclic fractions of saturated, unsaturated or aromatic character.

Specified by way of example as (meth)acrylate monomers of the formula (II) are ethylene glycol di(meth)acrylate, propylene glycol di(meth)acrylate, butylene glycol di(meth)acrylate, 1,6-hexanediol di(meth)acrylate, neopentyl glycol di(meth)acrylate, bisphenol A di(meth)acrylate, polyethylene glycol di(meth)acrylate, polypropylene glycol di(meth)-acrylate, and ethoxylated bisphenol A di(meth)acrylate.

Polyalkylene glycol di(meth)acrylates have emerged as being particularly suitable.

Also suitable in principle are (meth)acrylate monomers of higher functionality, such as, for example, trimethylolpropane tri(meth)acrylate, pentaerythritol tri(meth)acrylate, suitable for use. In these cases, however, it is preferred for at least one monofunctional or difunctional (meth)acrylate monomer to be present.

Having proven particularly suitable as organic (meth)acrylate are tetrahydrofurfuryl methacrylate and tetrahydrofurfuryl acrylate and also their blends with other (meth)acrylates. Tetrahydrofurfuryl methacrylate is preferred.

In one embodiment of the invention the composition of the invention comprises at least two (meth)acrylate monomers of the formula (I) and/or formula (II). Preferably at least one of them is tetrahdyrofurfuryl methacrylate or tetrahydrofurfuryl acrylate.

(Meth)acrylate oligomers are more particularly oligomers obtained by partial polymerization of the monomers possessing suitability as (meth)acrylate monomer. These oligomers, however, must still contain at least one (meth)acrylate group.

The sum by weight of all the organic (meth)acrylates is more particularly more than 30% by weight, preferably between 40% and 80% by weight, based on the composition.

The composition further comprises zinc(II) dimethacrylate. It has been possible to show that neither zinc(II) diacrylate nor zinc(II) monomethacrylate shows the desired effects.

Zinc(II) dimethacrylate is available commercially, for example, under the name Zinc methacrylate from Aldrich or Gelest Inc., or under the trade name SR708 from Sartomer.

Zinc(II) dimethacrylate is used preferably in an amount of 0.01% to 10% by weight, more particularly of 3% to 8% by weight, based on the composition.

The composition further comprises a metal oxide. This metal oxide is an oxide of a divalent or trivalent metal M and possesses the formula MO or M₂O₃. The metal in this case is selected from the group consisting of zinc and the main-group metals. The divalent or trivalent metal M is more particularly Be(II), Mg(II), Ca(II), Sr(II), Ba(II), Al(III) or Zn(II), preferably Mg(II), Ca(II), Sr(II), Ba(II), Al(III) or Zn(II).

A particularly preferred trivalent metal M is Al(III). A particularly preferred divalent metal M is Mg(II), Ca(II) or Zn(II).

Divalent metals are preferred over trivalent metals. The most preferred metal oxides are ZnO or MgO. The maximally preferred metal oxide is magnesium(ii) oxide, MgO.

These metal oxides may be natural or may have been produced synthetically. They are used preferably in the form of powders. They preferably have a high specific surface area.

The fraction of all the divalent or trivalent metal oxides of the formula MO and M₂O₃, more particularly of all the oxides of divalent metals, is chosen preferably such that their sum by weight amounts to a value between 0.01% and 20% by weight, more particularly between 0.1% and 10% by weight, preferably between 0.5% and 5% by weight, based on the composition.

The weight ratio of zinc(II) dimethacrylate to metal oxide amounts preferably to a value of 1:2-120:1, more particularly 2:1-20:1, preferably 5:1-15:1.

Compositions which have emerged as being particularly suitable are those which comprise a content of
30%-70%, more particularly 40%-60%, by weight of organic (meth)acrylate;
1%-15%, more particularly 2%-12%, by weight of zinc(II) dimethacrylate;
and also 0.01%-10%, more particularly 0.1%-5%, by weight of metal oxide.

The compositions may where appropriate comprise further constituents.

Additional constituents of this kind are core-shell polymers, liquid rubbers, catalysts, organic and inorganic fillers, dyes, pigments, inhibitors, UV stabilizers, heat stabilizers, antistatics, flame retardants, biocides, plasticizers, waxes, flow control agents, adhesion promoters, thixotropic agents, and further common raw materials and additives that are known to the skilled person.

Suitable catalysts are on the one hand, more particularly, tertiary amines such as N,N-dimethylaniline, N,N-dimethyl-p-toluidine, N,N-diethylaniline, N,N-diethyltoluidine, N,N-bis(2-hydroxyethyl)-p-toluidine, N-ethoxylated p-toluidines, N-alkyl-morpholines or mixtures thereof, for example. Suitability on the other hand is possessed by transition metal salts or transition metal complexes, more particularly those of the metals cobalt, manganese, vanadium, and copper, as catalysts.

Suitable adhesion promoters include more particularly alkoxysilanes and (meth)acrylates containing phosphorus atoms.

Suitable polymerization inhibitors are more particularly hydroquinones, more particularly hydroquinone and methylhydroquinones, or t-butyl-p-cresol.

Particularly suitable additional constituents, alongside catalysts, are more particularly core-shell polymers and liquid rubbers.

Core-shell polymers are composed of an elastic core polymer and a rigid shell polymer. Core-shell polymers suitable more particularly are composed of a core of crosslinked elastic acrylate or butadiene polymer which has been grafted onto a rigid shell of a rigid thermoplastic polymer.

Particularly suitable core-shell polymers are those which swell, but do not dissolve, in the organic (meth)acrylate.

Preferred core-shell polymers are what are known as MBS polymers, which are available commercially under the trade name Clearstrength™ from Atofina or Paraloid™ from Rohm and Haas. The core-shell polymers are used preferably in an amount of 5% to 40% by weight, based on the composition.

Suitable liquid rubbers are more particularly butadiene/acrylonitrile copolymer-based liquid rubbers or polyurethane-based liquid rubbers. The liquid rubbers preferably contain unsaturated double bonds.

As particularly suitable liquid rubbers have on the one hand vinyl-terminated butadiene/acrylonitrile copolymers, of the kind offered commercially as part of the product series Hycar® VTBNX from BFGoodrich®, or from Noveon.

Considered particularly suitable liquid rubbers on the other hand are (meth)acrylate-terminated polyurethane polymers. Polymers of this kind can be prepared from polyols and polyisocyanates with formation of isocyanate-functional polyurethane prepolymers and subsequent reaction with hydroxyalkyl (meth)acrylates.

Preferred isocyanate-functional polyurethane prepolymers are the reaction product of a polyisocyanate, more particularly of a diisocyanate, and of a polyol in a ratio of isocyanate group equivalents to hydroxyl group equivalents of greater than 1. Consequently, adducts of the type NCO-xx-NHCO—O-yy-O—OCONH-xx-OCN are also understood as polyurethane prepolymers in this context, where xx stands for a diisocyanate without NCO groups and yy stands for a diol without OH groups.

In principle it is possible for this purpose to use any polyol HO—R—(OH)_{q} with q≧1, R standing for a polymer backbone with heteroatoms in the backbone or as side chains.

Preferred polyols are polyols which are selected from the group consisting of polyoxyalkylene polyols, also called “polyether polyols”, polyester polyols, polycarbonate polyols, and mixtures thereof. Preferred polyols are diols. The most-preferred diols are polyoxyethylene diols or polyoxypropylene diols or polyoxybutylene diols.

The polyoxyalkylene polyols may have a low degree of unsaturation (measured in accordance with ASTM D-2849-69 and reported in milliequivalents of unsaturation per gram of polyol (meq/g)), prepared for example using what are known as double metal cyanide complex catalysts (DMC catalysts), or else may have a higher degree of unsaturation, being prepared for example by means of anionic catalysts such as NaOH, KOH, CsOH or alkali metal alkoxides.

The use of polyoxyalkylene polyols with a low degree of unsaturation, more particularly of less than 0.01 meq/g, is preferred for polyols having a molecular weight of ≧2000.

In principle it is possible to use any polyisocyanates having two or more isocyanate groups.

Mention may be made, by way of example, of 2,4- and 2,6-tolylene diisocyanate (TDI) and mixtures thereof, 4,4′-diphenylmethane diisocyanate (MDI), any isomers of diphenylmethane diisocyanate, 1,3- and 1,4-phenylene diisocyanate, 2,3,5,6-tetramethyl-1,4-diisocyanatobenzene, 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodecamethylene diisocyanate, cyclohexane 1,3- and 1,4-diisocyanate and any mixtures of these isomers with one another, 1-isocyanato-3,3,5-trimethyl-5-isocyanatomethylcyclohexane (i.e., isophorone diisocyanate or IPDI), perhydro-2,4′- and -4,4′-diphenylmethane diisocyanate (HMDI), 1,4-diisocyanato-2,2,6-trimethylcyclohexane (TMCDI), m- and p-xylylene diisocyanate (XDI), 1,3- and 1,4-tetramethylxylylene diisocyanate (TMXDI), 1,3- and 1,4-bis(isocyanatomethyl)cyclohexane, any oligomers or polymers of the abovementioned isocyanates, and also any mixtures of the stated isocyanates with one another. Preferred polyisocyanates are MDI, TDI, HDI, IPDI and their mixtures with one another. Most preferred are IPDI and HDI and a mixture thereof.

The isocyanate-terminated prepolymers prepared from the polyols and polyisocyanates are reacted with (meth)acrylic esters which contain hydroxyl groups. Preferred (meth)acrylic esters which contain hydroxyl groups are hydroxyethyl (meth)acrylate or hydroxypropyl (meth)acrylate. The two reactants are reacted with one another in a manner which is known per se, typically in a stoichiometric excess of the (meth)acrylic ester which contains hydroxyl groups.

The preferred (meth)acrylate-terminated polyurethane polymer is the reaction product of an IPDI/polypropylene glycol-polyurethane prepolymer or of an HDI/polypropylene glycol-polyurethane prepolymer with hydroxyethyl (meth)acrylate or with hydroxypropyl (meth)acrylate.

The polyurethane prepolymer and/or the (meth)acrylate-terminated polyurethane polymer may be prepared in the presence of the organic (meth)acrylate provided the latter contains no NCO-reactive groups.

The liquid rubbers are used preferably in an amount of 5% to 40% by weight, based on the composition.

Compositions which have emerged as being particularly suitable are those which comprise at least one organic (meth)acrylate, zinc(II) dimethacrylate, at least one metal oxide of a divalent or trivalent metal, and also a core-shell polymer and a liquid rubber.

The composition ought preferably to have a neutral or slightly basic pH.

The compositions can be prepared in principle with the apparatus and methods that are known to the skilled worker. More particularly, however, the following preparation method has proven advantageous:

The organic (meth)acrylate is charged to a reaction vessel. Subsequently the core-shell polymer and/or liquid rubber, where present, is incorporated with stirring. Finally zinc(II) dimethacrylate and metal oxide are incorporated with stirring, any further raw materials such as activators, adhesion promoters, additives, etc. When a homogeneous composition has been obtained, it is deaerated where appropriate and packaged.

The composition may be cured thermally, by radiation or by chemical generation of free radicals.

Preference is given to curing by chemical free-radical generation.

Accordingly, the invention further provides a free-radically curing, two-component composition which is composed of a first component K1 and a second component K2. For this purpose the raw materials used are distributed between the two components in such a way as to ensure sufficient storage stability. One preferred such two-component composition is described as follows:

The first component K1 forms the above-described composition.

The second component K2 comprises a free-radical initiator. This free-radical initiator is more particularly a peroxide or a perester. Suitable peroxide includes not only hydrogen peroxide but also, in particular, organic peroxides or hydroperoxides.

The organic peroxides or hydroperoxides which can be used are governed by the fields of use, temperatures, and chemical compatibility with other raw materials. A peroxide which has proven particularly preferred is dibenzoyl peroxide. Preferred hydroperoxides are more particularly cumene hydroperoxide and isopropylcumene hydroperoxide.

A preferred free-radical initiator is dibenzoyl peroxide.

Component K2 may comprise further constituents. More particularly these are the additional constituents specified above in the context of the composition acting as component K1, subject to the condition that these additional constituents do not undergo any significant reaction, at least during the storage period, with other ingredients such as the free-radical initiator, for example.

Components K1 and K2 preferably possess comparable viscosities.

Preferably the volume ratio of component K1 to K2 is between 20:1 and 1:2, preferably approximately 10:1.

For curing, components K1 and K2 are mixed. The resulting mixture is preferably pasty and more preferably thixotropic. Components K1 and K2 are kept in separate containers prior to mixing.

A further aspect of the invention concerns a pack which is composed of packaging and contents.

The packaging here features two mutually separate chambers. The contents are a two-component, free-radically curing composition consisting of a first component K1 and a second component K2, as just described. In this arrangement, component K1 is present in one chamber and component K2 in the other chamber of the packaging.

The packaging forms a unit in which the two chambers are held together or connected directly to one another.

The two chambers are separated from one another via a partable separation. This separation may be, for example, a film or a breakable layer or one or two closures which seal off an opening (13). In one preferred embodiment the packaging constitutes a double cartridge. More particularly it is designed as a twin cartridge (8) or coaxial cartridge (9). In the twin cartridge there are two tubelike containers present which are adjacent to one another, connected to one another in the longitudinal direction, where appropriate, by webs or by a connecting seam or an envelope, such as by a film, for example, these containers being closed on one side with a displaceable piston (11) and each having on the other side a closed-off opening (13), typically arranged together in an outlet piece.

The coaxial cartridge corresponds to the twin cartridge, with the difference that the tubelike containers are arranged not adjacent to one another but rather inside one another, so forming a tube-in-tube arrangement.

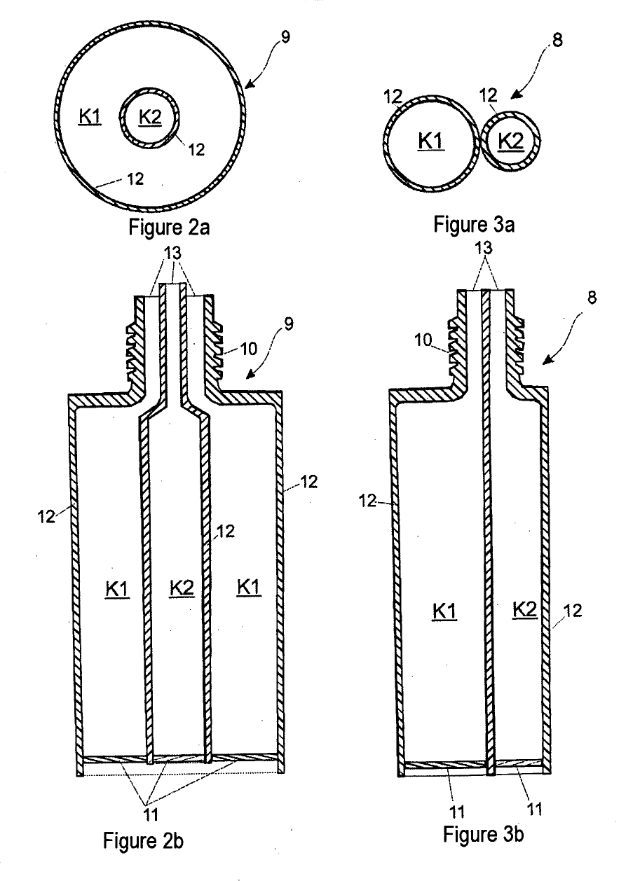

FIGS. 2 and 3 respectively show this kind of coaxial cartridge and twin cartridge (cross section (FIG. 2a, 3a) longitudinal section (FIG. 2b, 3b)).

Cartridge packaging of this kind is prior art for two-component compositions.

A further packaging possibility is formed by a multi-chamber tubular pouch or a multi-chamber tubular pouch with adapter, of the kind disclosed in WO 01/44074 A1, for example, whose content is therefore included as subject matter of the present invention.

It has been found that, with the compositions of the invention, storage-stable compositions can be obtained which, after curing, give rise to flexible materials which, even at high temperatures, still exhibit enhanced mechanical properties and good adhesion to a variety of substrates.

The terms “good mechanical properties” or “enhanced mechanical properties” in this document refer more particularly to a high storage modulus, a high glass transition temperature, a high tensile shear strength, a high shear stability, and a high breaking extension, more particularly in combination with one another simultaneously.

The composition of the invention, and the free-radically curing two-component composition of the invention, can be put to diverse uses. Preference is given on the one hand to the use thereof as an adhesive, and on the other hand as a coating, more particularly as a primer, paint or floor covering.

The composition will be formulated differently depending on its use, in order to meet the specific requirements. Differences include, for example, viscosity, surface aspects, and pot life.

A particularly preferred use of the composition, or of the free-radically curing, two-component composition, is its use as an adhesive.

For adhesive bonding, use is made more particularly of a method which comprises the following steps:
mixing the components K1 and K2 of a two-component, free-radically curing, two-component composition as described above,
applying the mixed two-component composition to at least one substrate surface to be bonded,
joining the adherends within the open time, and
curing the two-component composition.

Mixing is accomplished preferably by means of a static mixer, which can be mounted onto the two-chamber packaging used preferably for this method.

The substrate to whose surface the mixed adhesive is applied may vary greatly. It may be composed, for example, of a plastic, glass, ceramic, a mineral product, concrete, wood, woodbase material, metal or a metal paint.

The method is particularly suitable for the adhesive bonding of plastic, glass, wood or metal.

Joining of the adherends within the open time is accomplished by contacting the adhesive with a second surface of a substrate. This substrate may consist of the same material or of a different material from the substrate to which the adhesive has been applied.

It is within the confines of the invention for one and/or the other substrate to have possibly been pretreated with a primer or adhesion promoter composition before the adhesive is applied and/or the adhesive is contacted. Preferably there is no pretreatment of the substrate by means of primer or an adhesion promoter composition.

As a result of the adhesive bonding, articles are formed which may be diverse in nature. More particularly they are industrially manufactured articles.

Articles of this kind are on the one hand, more particularly, industrially manufactured means of transport or modules for installation in or on a means of transport. More particularly these are articles on an automobile or a heavy goods vehicle, a bus or a rail-vehicle or watercraft.

On the other hand they are what are known as white goods, such as washing machines, dishwashers, kitchen appliances, and electrical and electronic appliances, for example.

On the other hand they are industrially manufactured articles for constructing buildings or for use in civil engineering or construction. More particular preference is given to doors or windows. Windows are considered the most preferred.

In one further preferred embodiment the articles formed are architectural facing elements, composed more particularly of glass or metallic materials. Architectural facing elements of this kind may be, for example, facing panels or elements.

In one particularly preferred embodiment the adhesive is used for the bonding of glass sheets to a door frame or window frame which has been manufactured more particularly from wood, aluminum or a plastic, preferably PVC.

An important aspect of the invention is the use of a metal oxide of a divalent or trivalent metal, of the formula MO or M₂O₃, more particularly MO, in order to increase the storage stability of a composition comprising at least one organic (meth)acrylate and zinc(II) dimethacrylate. M here stands for a main-group metal or zinc. The possibilities and preferred embodiments have already been mentioned above.

Hence it is possible to prepare compositions which not only at room temperature but also at temperatures between 50° C. and 150° C., more particularly between 70° C. and 120° C., exhibit good adhesion and mechanical properties on a broad range-of-materials, but which are still flexible and exhibit good storage stability.

“Flexible” here refers to breaking elongations of more than 20%, more particularly of more than 50%, preferably of more than 100%. Where the composition in question is an adhesive, it is possible at these elongations to achieve, at 80° C., for example, tensile shear strengths of more than 3 MPa, more particularly more than 4 MPa.

It is possible to achieve compositions having glass transition temperatures of more than 60° C.

The compositions, relative to noninventive compositions, more particularly those with zinc(II) dimethacrylate and (meth)acrylate monomer without metal oxide, exhibit increased storage stability not only at room temperature but also at elevated temperature.

In order to obtain a rapid conclusion concerning the storage stability, it is possible, in a manner known to the skilled worker, for storage to take place at elevated temperature (e.g., 42° C. or 50° C.), in order to obtain a quickly accessible indicator of the storage stability at room temperature.

The term storage stability is understood in this document to mean that a composition, more particularly its constitution, should exhibit little or no change during the storage period. As a measure of the determination of the storage stability a determination is made of the point in time at which the composition, or its viscosity, has altered to such an extent that application is no longer possible, or the composition undergoes gelling.

The compositions of the invention exhibit storage stabilities at room temperatures of more than 6 months, more particularly of more than 9 months. It has emerged that at 50° C. it is necessary to ensure a storage stability of at least 10 days. The compositions of the invention have a storage stability at 50° C. more particularly of at least 10 days, more particularly of more than 1 month, preferably of more than 2 months.

Preference is given to compositions which exhibit a storage stability of at least 10 days, more particularly of more than 50 days, at 50° C., and also a tensile shear strength (23° C.) on aluminum of more than 10 MPa, more particularly of more than 13 MPa, a breaking elongation (23° C.) of more than 50%, more particularly of more than 100%, a glass transition temperature of more than 50° C., more particularly of more than 60° C., a storage modulus G′ (80° C.) of more than 10 MPa, more particularly of more than 12 MPa, and a tensile strength (23° C.) of more than 10 MPa, more particularly of more than 12 MPa.

### EXAMPLES

### Compositions

The examples of compositions as indicated in table 1 were prepared. This was done by dissolving the liquid rubber and the N,N-dimethyl-p-toluidine in the monomer, in a dissolver, and then incorporating the core-shell polymer. Thereafter the metal (meth)acrylate and the metal oxide (or metal carbonate) and also the thixotropic agents were incorporated with stirring until a macroscopically homogeneous paste was obtained. Following deaeration, the paste formed was dispensed into 250 ml twin cartridges.

The inventive and comparative examples from table 1 were stored at different temperatures until gelling was ascertained.

For the characterization of the mechanical properties and adhesive bonds, the compositions of table 1 were mixed in a volume ratio of 10:1 with a curative paste (consisting of 25% dibenzoyl peroxide in plasticizers and mineral fillers).

The tensile strength (“TS”) was determined in accordance with ISO 527 at 23° C.

The breaking extension (“BE”) was determined in accordance with ISO 527 at 23° C.

The results are compiled in table 2.

The tensile shear strength (“TSS”) was determined in a method based on ISO 4587/DIN EN 1465 on a Zwick/Roell Z005 tensile machine (bond area: 12 mm×25 mm, film thickness: 1.5 mm, measuring speed: 10 mm/min, substrate: aluminum (100 mm×25 mm×2 mm), temperature: 23° C. (unless stated otherwise), pretreatment: Sika®ADPrep (Sika Schweiz AG)).

A torsion pendulum was used in accordance with DIN EN 61006 to determine the glass transition temperature (“Tg”) and in accordance with DIN EN ISO 6721-2 to determine the storage modulus (“G′”).

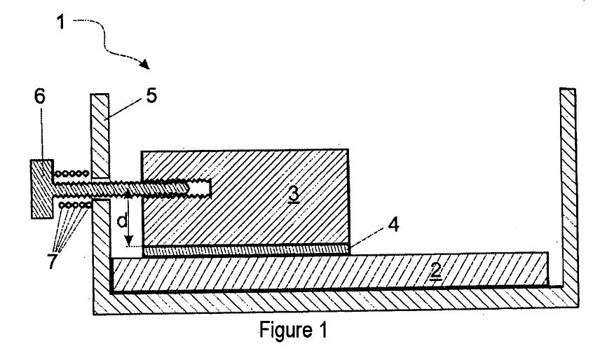

The shear stability (“SS”) was determined by means of the apparatus (1) which is shown diagrammatically in FIG. 1. For this purpose, a glass specimen (2) and an aluminum block (3) are bonded by means of the respective composition (4) in a film thickness of 0.7 mm with an area of 25 mm×20 mm. The aluminum specimen has in its side face an M8 threaded bore (distance (d) between aluminum bond area and center point of bore: 7.5 mm). The bonded specimen was inserted flush in a steel frame (5) which at the level of the aluminum specimen has a hole, through which a tensioning screw (6) has been introduced, and was screwed into the aluminum body. By rotation of the screw, a spring (7) with a known spring constant was compressed and in this way defined forces were set.

The sequence used to measure the shear stability was then as follows: 0.1 MPa was set (tensile force/bond area). The specimen was then stored in an oven at 80° C. for 30 days. If the specimen cracked, a value of “<0.1 MPa” was recorded. If the assembly was still intact, a newly produced assembly was loaded with 0.2 MPa and stored likewise at 80° C. for 30 days. If the test was passed, this procedure was continued with increasing values, i.e., 0.3 MPa, 0.4 MPa, and 0.5 MPa, etc. The measurement recorded is the last tension which is still withstood.

Table 3 shows tensile shear strengths of inventive example 6, and hence the adhesions to different substrates.

### LIST OF REFERENCE SYMBOLS

1 Apparatus for determining the shear stability
2 Glass specimen
3 Aluminum block
4 Composition
5 Steel frame
6 Tensioning screw
7 Spring
8 Twin cartridge
9 Coaxial cartridge
10 Thread
11 Displaceable piston
12 Chamber wall
13 Opening

FIG. 1 shows a cross section through an apparatus for determining the shear stability

FIG. 2 shows a coaxial cartridge (cross section FIG. 2a, longitudinal section FIG. 2b)

FIG. 3 shows a twin cartridge (cross section FIG. 3a, longitudinal section FIG. 3b)

TABLE 1
Compositions (amounts in parts by weight).

| | Ref. 1 | Ref. 2 | Ref. 3 | 1 | 2 | Ref. 4 | 3 | Ref. 5 | 4 | 5 | Ref. 6 | 6 |
|---|---|---|---|---|---|---|---|---|---|---|---|---|
| Tetrahydrofurfuryl | 55 | 55 | 55 | 55 | 55 | 54.5 | 54.5 | 54.5 | 54.5 | 54.5 | 54.5 | 54.5 |
| methacrylate | | | | | | | | | | | | |
| Zn(II) dimethacrylate | 8 | | | 8 | 8 | 8 | 8 | 8 | 8 | 8 | 8 | 8 |
| Zn(II) diacrylate | | 8 | | | | | | | | | | |
| Zn(II) monomethacrylate | | | 8 | | | | | | | | | |
| MgO | | | | 1 | 2 | | | | | | | 2 |
| MgCO₃ | | | | | | 1 | | | | | | |
| CaO | | | | | | | 2 | | | | | |
| CaCO₃ | | | | | | | | 2 | | | | |
| ZnO | | | | | | | | | 6 | 10 | | |
| ZnCO₃ | | | | | | | | | | | 2 | |
| Core Shell Polymer | 20 | 20 | 20 | 20 | 20 | 20 | 20 | 20 | 20 | 20 | 20 | 20 |
| Hycar ® VTBNX | 14 | 14 | 14 | 14 | 14 | 14 | 14 | 14 | 14 | 14 | 14 | |
| PU methacrylate* | | | | | | | | | | | | 14 |
| Thixotropic agent | 2 | 2 | 2 | 2 | 2 | 2 | 2 | 2 | 2 | 2 | 2 | 2 |
| N,N-Dimethyl-p-toluidine | 1.5 | 1.5 | 1.5 | 1.5 | 1.5 | 1.5 | 1.5 | 1.5 | 1.5 | 1.5 | 1.5 | 1.5 |
| Total | 100 | 100 | 100 | 101 | 102 | 101 | 102 | 102 | 106 | 110 | 102 | 102 |

*Molecular weight 4700 g/mol, methacrylate functionality = 2.

TABLE 2
Results.

| | Ref. 1 | Ref. 2 | Ref. 3 | 1 | 2 | Ref. 4 | 3 | Ref. 5 | 4 | 5 | Ref. 6 | 6 |
|---|---|---|---|---|---|---|---|---|---|---|---|---|
| tₛ (23° C.) [d] | 180 | >240 | >180 | >240 | >240 | n.d. | >240 | n.d. | >240 | >240 | >240 | >240 |
| tₛ (42° C.) [d] | 24 | >240 | >180 | >120 | >120 | 31 | >120 | 31 | 45 | 45 | 38 | >240 |
| tₛ (50° C.) [d] | 7 | >240 | >180 | >120 | >120 | 7 | 120 | 5 | 10 | 17 | 6 | >50 |
| TS [MPa] | 14.1 | 11.2 | 13 | 14.6 | 16.2 | 15.2 | 14 | 14.3 | 15.4 | 16.5 | 15.2 | 13.8 |
| BE [%] | 70 | 157 | 147 | 98 | 67 | 79 | 101 | 102 | 112 | 103 | 88 | 115 |
| T_{g} [° C.] | 66 | 57 | 60 | 63 | 66 | n.d. | 60 | n.d. | 62 | 61 | n.d. | 66 |
| G′ (80° C.) [MPa] | 10.5 | 2.6 | 4.1 | 11 | 14 | n.d. | 7 | n.d. | 13 | 10 | n.d. | 17 |
| TSS (23° C.) [MPa] | 13.1 | 10 | n.d. | 11.3 | 13.3 | 15 | 12.6 | 15.5 | 10.9 | 16.1 | 13.3 | 14.2 |
| TSS (80° C.) [MPa] | 4.1 | 1.7 | 1.6 | 4.2 | 6.1 | 3.2 | 5 | 3 | 2.9 | 3.2 | 6.5 | 4.5 |
| SS (80° C.) [MPa] | 0.4 | <0.1 | n.d. | n.d. | 0.5 | n.d. | n.d. | n.d. | n.d. | n.d. | n.d. | 0.5 |

tₛ = storage time,
TS = tensile strength,
BE = breaking extension,
T_{g} = glass transition temperature,
G′ (80° C.) = storage modulus at 80° C.,
TSS = tensile shear strength,
SS = shear stability,
n.d. = not determined.

TABLE 3
Tensile shear strengths [MPa] on different substrates.

| | AlMg3 | AlMg3 | Glass | PVC | Spruce | Pine | Meranti |
|---|---|---|---|---|---|---|---|
| | (23° C.) | (80° C.) | (23° C.) | (23° C.) | (23° C.) | (23° C.) | (23° C.) |
| 6 | 13.5 | 4.5 | 10.6 | 7.9 | 5.5 | 7.6 | 5.7 |

1. A composition comprising
at least one organic (meth)acrylate;
zinc(II) dimethacrylate
and also at least one metal oxide of a divalent or trivalent metal which is selected from the group consisting of zinc and the main-group metals, of the formula MO or M₂O₃.

2. The composition of claim 1, wherein the metal oxide is an oxide of zinc or of a divalent main-group metal.

3. The composition of claim 1, wherein the metal oxide is zinc(II) oxide or magnesium(II) oxide or calcium(II) oxide.

4. The composition of claim 1, wherein the composition further comprises at least one core-shell polymer.

5. The composition of claim 1, wherein the composition further comprises at least one liquid rubber.

6. The composition of claim 1, wherein a fraction of the sum by weight of all organic (meth)acrylates is more than 30% by weight, based on the composition.

7. The composition of claim 1, wherein the fraction of the sum by weight of all the metal oxides is between 0.01% and 20% by weight, based on the composition.

8. The composition of claim 1, wherein a weight ratio of zinc(II) dimethacrylate and metal oxide is 1:2-120:1.

9. A composition comprising
30%-70% by weight of organic (meth)acrylate;
1%-15% by weight of zinc(II) dimethacrylate
0.01%-10% by weight of metal oxide.

10. A free-radically curing, two-component composition consisting
of a first component K1,
which represents a composition of claim 1; and of a second component K2,
which comprises at least one peroxide or perester.

11. The free-radically curing, two-component composition of claim 10, wherein a volume ratio of component K1 to K2 is between 20:1 and 1:2.

12. A pack consisting of packaging having two mutually separate chambers and contents which represent a two-component composition of claim 10, component K1 being present in one chamber and component K2 being present in the other chamber.

13. A method of adhesive bonding comprising bonding two surfaces together with a composition of claim 1 as an adhesive.

14. A primer, paint or floor covering comprising a composition of claim 1.

15. A method of adhesive bonding two surfaces comprising the steps of:
mixing the components K1 and K2 of a two-component, free-radically curing composition of claim 10,
applying the mixed two-component composition to at least one said surface to be bonded,
joining the surfaces before the composition cures, and
curing the two-component composition.

16. An article obtained by the method of adhesive bonding of claim 15.

17. The article of claim 16, wherein the article is a means of transport or a module for installation in or on a means of transport.

18. The article of claim 16, wherein the article is a window or a door or belongs to an architectural facing.

19. A method of increasing storage stability of a composition comprising at least one organic (meth)acrylate and zinc(II) dimethacrylate, comprising adding to said composition a metal oxide of a divalent or trivalent metal which is selected from the group consisting of zinc and the main-group metals, of the formula MO or M₂O₃.

20. The method of claim 19, wherein the metal oxide is zinc(II) oxide or magnesium(II) oxide or calcium(II) oxide.
